(19) United States
(12) Patent Application Publication
(10) Pub. No.: US 2021/0358444 A1
(43) Pub. Date: Nov. 18, 2021

(54) DRIVE ADJUSTING CIRCUIT AND ADJUSTING METHOD, DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Hongwei DAI, Beijing (CN); Fucheng YANG, Beijing (CN)

(21) Appl. No.: 16/331,433

(22) PCT Filed: Sep. 4, 2018
(86) PCT No.: PCT/CN2018/103975

§ 371 Date: Mar. 7, 2019

(30) Foreign Application Priority Data
Dec. 8, 2017 (CN) 201711297125.5

(51) Int. Cl. G09G 3/36

(52) U.S. Cl. CPC G09G 3/3696; G09G 2320/029; G09G 3/3677; G09G 3/3688

(57) ABSTRACT

A drive adjusting circuit, a method of adjusting a drive and a display device. The method of adjusting a drive includes: obtaining a charging error value of a pixel group; determining an adjustment strategy of the drive based on the charging error value; and adjusting a setting of the drive based on the adjustment strategy, wherein the determining an adjustment strategy of the drive based on the charging error value includes: reducing the drive in a case where the charging error value meets a first condition; and increasing the drive in a case where the charging error value meets a second condition.

The present application claims priority to Chinese Patent Application No. 201711297125.5, filed on Dec. 8, 2017, the disclosure of which is incorporated herein by reference in its entirety as part of the present application.

### TECHNICAL FIELD

The embodiments of the present disclosure relate to a drive adjusting circuit and a drive adjusting method, and a display device.

### BACKGROUND

A thin film transistor-liquid crystal display (TFT-LCD) is a maintenance electro-optical converting device. Having being output from a data-driven IC (Integrate Chip), a gray-scale voltage corresponding to a certain brightness is written into a pixel electrode by a data line after a thin film transistor (TFT) which is used as a switch is turned on. The process of writing the gray-scale voltage into the pixel electrode is to charge the pixel electrode of a pixel unit, and the gray-scale voltage to be written into the pixel electrode of the pixel unit is close to a value output from the data-driven IC as far as possible.

### SUMMARY

At least an embodiment of the present disclosure provides a method of adjusting a drive, which comprises: obtaining a charging error value of a pixel group; determining an adjustment strategy of the drive based on the charging error value; and adjusting a setting of the drive based on the adjustment strategy, wherein the determining an adjustment strategy of the drive based on the charging error value comprises: reducing the drive in a case where the charging error value meets a first condition; and increasing the drive in a case where the charging error value meets a second condition.

For example, in the method of adjusting the drive provided by an embodiment of the present disclosure, each pixel unit in the pixel group is connected with a same scan line which is a gate line or a virtual gate line.

For example, in the method of adjusting the drive provided by an embodiment of the present disclosure, the pixel group comprises N pixel units which are charged by N writing voltage values provided by N data lines, wherein N is a total number of the data lines and is a positive integer greater than or equal to 1; and the obtaining a charging error value of a pixel group comprises: reading N writing voltage values of the N pixel units respectively; measuring voltage values on pixel electrodes of the N pixel units to obtain N charging voltage values; and obtaining N difference values by subtracting absolute values of the N writing voltage values from absolute values of the N charging voltage values, and determining the charging error value based on the N difference values.

For example, in the method of adjusting the drive provided by an embodiment of the present disclosure, the N writing voltage values are N data voltage values or N set fixed voltage values.

For example, in the method of adjusting the drive provided by an embodiment of the present disclosure, the scan line is connected with gates of drive transistors of the pixel units, the drive transistors are turned on under a control of a turn-on voltage provided by the scan line; and the obtaining N charging voltage values comprises reading the N charging voltage values before the drive transistors are turned off.

For example, in the method of adjusting the drive provided by an embodiment of the present disclosure, the charging error value is an average error value, the average error value is an average of the N difference values, and the average error value is used for representing an average charging error of the N data lines.

For example, in the method of adjusting the drive provided by an embodiment of the present disclosure, the determining an adjustment strategy of the drive based on the charging error value comprises: reducing a source drive voltage, a source drive current or a duty ratio of a clock signal in a case where the average error value is above a first threshold; or increasing the source drive voltage, the source drive current or the duty ratio of the clock signal in a case where the average error value is below a second threshold, wherein the first threshold is a positive real number, and the second threshold is a negative real number.

For example, in the method of adjusting the drive provided by an embodiment of the present disclosure, the charging error value comprises N independent error values, and the N independent error values are the N difference values and are used for representing charging error values of the N data lines respectively.

For example, in the method of adjusting the drive provided by an embodiment of the present disclosure, the determining an adjustment strategy of the drive based on the charging error value comprises: for each data line: reducing a source drive voltage or a source drive current of the data line in a case where the independent error value corresponding to the data line is above the first threshold; or increasing the source drive voltage or the source drive current of the data line in a case where the independent error value corresponding to the data line is below the second threshold, wherein the first threshold is a positive real number, and the second threshold is a negative real number.

For example, in the method of adjusting the drive provided by an embodiment of the present disclosure, the obtaining N difference values by subtracting absolute values of the N writing voltage values from absolute values of the N charging voltage values comprises: obtaining a time interval between two adjacent frames of image data input by a host to a drive circuit; and calculating the N difference values within the time interval.

The embodiments of the present disclosure further provide a drive adjusting circuit, comprising: a processing subcircuit configured to obtain a charging error value of a pixel group; a strategy generation subcircuit configured to determine an adjustment strategy of the drive based on the charging error value; and a setting subcircuit configured to adjust a setting of the drive based on the adjustment strategy, wherein the strategy generation subcircuit is further configured to reduce the drive in a case where the charging error value meets a first condition; and to increase the drive in a case where the charging error value meets a second condition.

For example, in the drive adjusting circuit provided by an embodiment of the present disclosure, the pixel group comprises N pixel units which are charged by N writing voltage values provided by N data lines respectively, wherein N is a total number of the data lines and is a positive integer greater than or equal to 1; and the processing subcircuit is further configured to: read N writing voltage values of the N pixel units respectively; measure voltage values on pixel electrodes of the N pixel units to obtain N charging voltage values; and obtain N difference values by subtracting absolute values of the N writing voltage values from absolute values of the N charging voltage values, and determine the charging error value based on the N difference values.

For example, in the drive adjusting circuit provided by an embodiment of the present disclosure, the strategy generation subcircuit is further configured to: compare the charging error value with a set first threshold and a set second threshold to obtain a comparison result; and generate the adjustment strategy for adjusting the drive based on the comparison result, wherein the first threshold is a positive real number and the second threshold is a negative real number.

For example, in the drive adjusting circuit provided by an embodiment of the present disclosure, each pixel unit in the pixel group is connected with a same scan line, and the scan line is a gate line or a virtual gate line.

The embodiments of the present disclosure further provide a display device, comprising any above-mentioned drive adjusting circuit, a gate drive circuit and a source drive circuit.

For example, in the display device provided by an embodiment of the present disclosure, the gate drive circuit is configured to configure a source drive voltage or a source drive current based on the setting of the drive; and the gate drive circuit is configured to reduce or increase a time taken by an output gate drive signal based on the setting of the drive.

### BRIEF DESCRIPTION OF THE DRAWINGS

In order to clearly illustrate the technical solution of the embodiments of the present disclosure, the drawings of the embodiments will be briefly described in the following. It is obvious that the described drawings are only related to some embodiments of the disclosure and thus are not limitative of the present disclosure.

FIG. 1 is a flow chart of a method of adjusting a drive according to an embodiment of the present disclosure;

FIG. 2 is a flow chart of obtaining one or more charging error values of a pixel group in step S200 of FIG. 1 according to an embodiment of the present disclosure;

FIG. 3 is a flow chart of a method of adjusting a drive according to an embodiment of the present disclosure;

FIG. 4 is a flow chart of a method of adjusting a drive according to an embodiment of the present disclosure;

FIG. 5 is a block diagram of a drive adjusting circuit according to an embodiment of the present disclosure;

FIG. 6A is a block diagram of a display device according to an embodiment of the present disclosure;

FIG. 6B is a schematic diagram of a connection of the display device with a host according to an embodiment of the present disclosure;

FIG. 6C is a circuit diagram of a GOA unit according to an embodiment of the present disclosure;

FIG. 6D is a timing diagram of the GOA unit according to an embodiment of the present disclosure; and

FIG. 6E is a schematic diagram of reading a charging voltage value of the pixel unit according to an embodiment of the present disclosure.

### DETAILED DESCRIPTION

The technical solutions of the embodiments of the present disclosure will be described in a clearly and fully understandable way in connection with the drawings related to the embodiments of the disclosure. With reference to non-limitative embodiments shown in the drawings and described in detail below, the embodiments of the present disclosure and their various features and advantageous details will be described more fully. It should be noted that the features shown in the drawings are not drawn in a real scale. The provided examples are only intended to facilitate understanding the implementation of the embodiments of the present disclosure, and so that the skilled in the field can implement the embodiments. Thus, these embodiments should not be construed to limit the scope of the embodiments of the present disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but to distinguish various components. In addition, in the embodiments of the present disclosure, the same or the similar reference labels represent the same or the similar components.

In the case where a drive circuit of a thin film transistor liquid crystal display (TFT-LCD) does not feed an actual charging voltage of the pixel unit hack to a drive circuit, the drive circuit cannot know an actual voltage value of each charged pixel unit.

A charging situation of the pixel unit on a display panel changes with an increase in usage time. If a drive control strategy provided by the drive circuit cannot detect these changes, an abnormity of the charging voltage of the pixel unit occurs, which causes abnormal display. Also, for the display panel with a relatively large size, due to the problem of uniformity, there is a relatively large charging difference of the pixel units at different positions of the display panel in a gate line direction, and display effects would be affected.

The embodiments of the present disclosure provide a drive adjusting circuit and a drive adjusting method, and a display device. In the embodiments of the present disclosure, a source drive adjustment strategy based on an average error may integrally adjust drive abilities of all data lines (for example, adjusting the drive ability may at least include the adjustment of one of a source drive voltage, a source drive current or a clock signal. For example, the clock signal may be adjusted by adjusting a timing control circuit, thereby adjusting the time taken by a high level output from a gate drive circuit), which effectively improves an overall degradation of drive abilities of the display panel with the increase in usage time. In the embodiments of the present disclosure, the source drive adjustment strategy based on an independent error is used for adjusting the drive ability of each data line respectively (for example, adjusting the drive ability at least includes the adjustment of either the source drive voltage or the source drive current), which effectively improves non-uniform display in the gate line direction of the panel with a relatively large size.

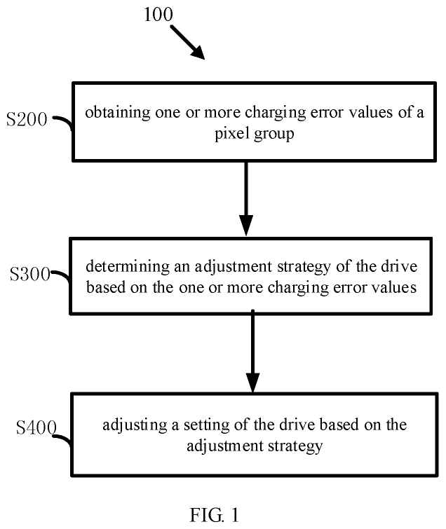

The method 100 of adjusting a drive, the drive adjusting circuit 10 and the display device 1 according to the present disclosure will be introduced in combination with FIGS. 1 to 6E below.

As shown in FIG. 1, the embodiment of the present disclosure provides a method IOU of adjusting a drive. The method 100 of adjusting the drive may include: step S200, obtaining one or more charging error values of a pixel group; step S300, determining an adjustment strategy of the drive based on the one or more charging error values; and step S400, adjusting a setting of the drive based on the adjustment strategy. For example, the determining an adjustment strategy of the drive based on the one or more charging error values may include: reducing the drive in the case where the one or more charging error values meet a first condition; and increasing the drive in the case where the one or more charging error values meet a second condition. For example, the drive includes at least one of a source drive (i.e., a source drive circuit) or a gate drive (i.e., a gate drive circuit).

In some embodiments, the pixel group in the step S200 may include one or more pixel units, all of which are connected with the same scan line which is a gate line or a virtual gate line.

For example, the gate line is located in an active display area on a display panel. A gate drive circuit turns on drive transistors line by line by controlling a plurality of gate lines to output on-state voltages of drive transistors orderly. In the case where the on-state voltages turn on the drive transistors, a plurality of data lines writes data voltage values into pixel units. It should be noted that the plurality of gate lines may be arranged in rows or columns. In the embodiments of the present disclosure, wiring direction and pattern of the gate lines are not limited.

For example, one or more virtual gate lines are arranged on a non-display area of the display panel, and the image may be output stably by arranging the one or more virtual gate lines. In some embodiments, the gate drive circuit controls one or more virtual gate lines to output the on-state voltages of the drive transistors orderly. In the case where the on-state voltage turns on the drive transistors, the plurality of data lines writes one or more fixed voltage values, which is/are set in advance, into the pixel units. It should be noted that the wiring direction and manner of the virtual gate lines are not limited in the embodiments of the present disclosure.

By obtaining one or more charging error values of the pixel group connected with the virtual gate line, the influence of obtaining one or more charging error values on the image display may be reduced.

In some embodiments, in the step S200, one or more charging error values of the pixel group may be obtained periodically, where the period of obtaining one or more charging error values of the pixel group may be adjusted dynamically. That is, the period of obtaining one or more charging error values of the pixel group may be adjusted dynamically with an increase in the usage time of the display panel. For example, in a case where the usage time of the display panel is short, one or more charging error values may be obtained during a period of displaying a plurality of frames of image data; with the increase in the usage time of the display panel, the period of obtaining one or more charging error values once may he shortened (for example, obtaining one or more charging error values once during the period of displaying one frame of image).

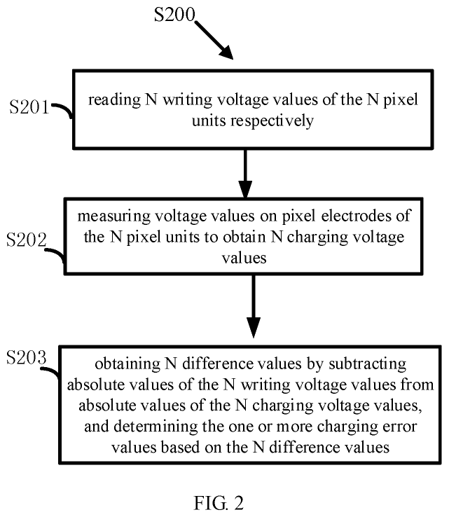

In some embodiments, the pixel group includes N pixel units which are charged by N writing voltage values provided by N data lines, where N is a total number of the data lines and is a positive integer greater than or equal to 1. In the corresponding step S200, the obtaining one or more charging error values of a pixel group may include each substep as shown in FIG. 2. For example, the pixel group includes one row or one column of pixel units.

As shown in FIG. 2, the step S200 of obtaining one or more charging error values of the pixel group may include: step S201, reading N writing voltage values of the N pixel units respectively; step S202, measuring voltage values on pixel electrodes of the N pixel units, so as to obtain N charging voltage values; and step S203, obtaining N difference values by subtracting absolute values of the N writing voltage values from absolute values of the N charging voltage values, and determining the one or more charging error values based on the N difference values.

In some embodiments, the writing voltage value in the step S201 is a data voltage value.

For example, the N pixel units in the pixel group are connected with gate lines of the active display area by the drive transistors. In the case where the gate line provides a turn-on voltage to the drive transistor, the drive transistor is turned on, and the N data lines write the data voltage value (for example, a gray-scale voltage value) to the pixel electrode of the pixel unit via the drive transistor. Afterwards, the N pixel units in the pixel group display image based on the data voltage values.

In some embodiments, the writing voltage value in the step S201 is a set fixed voltage value.

For example, the N pixel units in the pixel group are connected with virtual gate lines of a non-active display area by the drive transistor. In the case where the virtual gate line provides a turn-on voltage to the drive transistor, the drive transistor is turned on, and the N data lines write a preset fixed voltage value to the pixel electrode of the pixel unit via the drive transistor. It should be noted that the same fixed voltage value may be provided to the N pixel units, or a plurality of fixed voltage values is provided to the N pixel units, and the fixed voltage value is irrelevant to the displayed image.

In some embodiments, the step S202 of obtaining N charging voltage values may further include a step of reading charging voltage values, where in the case where N charging voltage values on the pixel electrodes of the N pixel units are read at the time when charging the N pixel units in the pixel group is finished, one or more charging error values which is or are more accurate may be obtained.

For example, the drive transistors are turned on under the control of the turn-on voltages provided by the scan lines, thereby the N data lines inputting the writing voltage values to the pixel electrodes of the pixel units via the drive transistors. In the step S202, the obtaining N charging voltage values includes reading the N charging voltage values on the pixel electrodes of the N pixel units before the drive transistors are turned off.

The charging voltage value is read at of the time when charging is finished, which avoids an inaccurate read charging voltage value due to discharging of the pixel unit, thereby affecting one or more obtained charging error values.

In some embodiments, N difference values in step S203 are calculated within an appropriate period. For example, a time interval between two adjacent frames of image data the host provided to the drive circuit is obtained, and the N difference values are calculated within this time interval. For example, the two adjacent frames of image data include a first frame of image data and a second frame of image data. Therefore, the time interval may represent the period from the host providing the first frame of image data to the drive circuit to the host providing the second frame of image data to the drive circuit. Since the drive circuit would not receive image data information from the host within this time interval, and does not charge the pixel unit of the display panel, there is a minimal influence on an operational burden of a CPU of the drive circuit.

In some embodiments, one charging error value in step S200 is an average error value which may be used for representing an average charging error of the N data lines. For example, the average error value may be an average of the N difference values obtained in step S203.

For example, the method 100 of adjusting the drive further includes: receiving a next frame of image data; and driving to display the next frame of image data using the setting of the drive.

For example, when one charging error value in step S200 is an average error value, the corresponding step S300 of determining an adjustment strategy of the drive based on one charging error value may include: in a case where the average error value is above a first threshold, reducing the drive ability (for example, reducing a source drive voltage, a source drive current or a duty ratio of a clock signal); or in a case where the average error value is below a second threshold, increasing the drive ability (for example, increasing the source drive voltage, the source drive current or a duty ratio of the clock signal). For example, the source drive voltage may be increased or reduced by adjusting the gray-scale voltage output from the source drive. For example, the source drive current may be increased or reduced by adjusting the current output from the source drive. For example, the duty ratio of the clock signal may be increased or reduced by adjusting the duty ratio of the clock signal output from a timing control circuit. For example, the first threshold is a positive real number, and the second threshold is a negative real number.

For example, in the present disclosure, the one or more charging error values meeting the first condition may indicate that the average error value is above the first threshold; the one or more charging error values meeting the second condition may indicate that the average error value is below the second threshold.

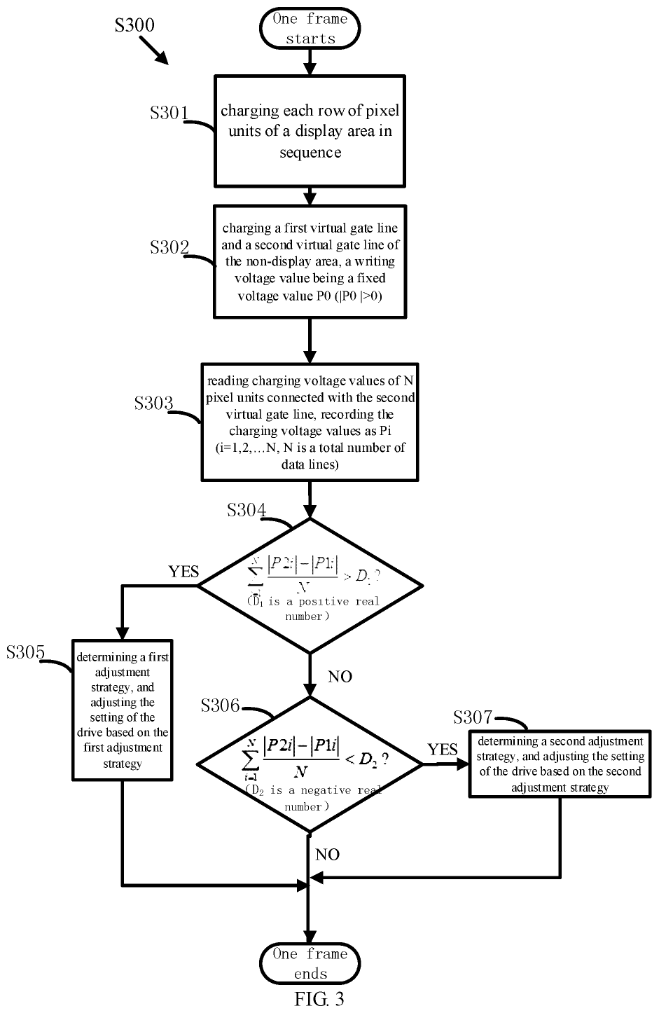

An embodiment of the present disclosure will be introduced in combination with FIG. 3 below, and the process of obtaining an adjustment strategy based on the average error value and adjusting the setting of the drive based on the adjustment strategy is explained in detail. It should be noted that in the embodiment shown in FIG. 3, two virtual gate lines are arranged in the non-display area, where N pixel units in the pixel group are connected with the second virtual gate line. It is assumed that the first threshold is D₁ and the second threshold is D₂, where D₁ is a positive real number and D₂ is a negative real number.

As shown in FIG. 3, the method 300 of adjusting the drive according to the embodiment shown in FIG. 3 may include:
step S301, charging each row of pixel units of a display area in sequence;
step S302, charging a first virtual gate line and a second virtual gate line of the non-display area, a writing voltage value being a fixed voltage value P1i ((i=1, 2, . . . N, N is a total number of data lines, |P1i|>0);
step S303, reading charging voltage values of N pixel units connected with the second virtual gate line, recording the charging voltage values as P2i (i=1, 2, . . . N, N is the total number of data lines);
step S304, comparing the average error value D with the first threshold D₁.

For example, in step S304, N difference values are calculated using the following formula (1), the average error value D is calculated according to the following formula (2), and then the average error value D is compared with the first threshold D₁:

$$\begin{matrix}D i = \vert P 2 i \vert - \vert P 1 i \vert & ( 1 ) \\ D = {\sum }_{i = 1}^{N} \frac{\vert P 2 i \vert - \vert P 1 i \vert}{N} & ( 2 )\end{matrix}$$

where P2i represents the charging voltage value on the pixel electrode of the ith pixel unit, and P1i represents a fixed voltage value corresponding to the ith pixel unit. If the average error value D is above the first threshold D₁, step S305 is performed, otherwise step S306 is performed.

Step S305, determining a first adjustment strategy, and adjusting the setting of the drive based on the first adjustment strategy.

Step S306, comparing the average error value D with the second threshold D₂; in a case where the average error value D is below the second threshold D₂, performing step S307, otherwise the drive is not adjusted.

Step S307, determining a second adjustment strategy, and adjusting the setting of the drive based on the second adjustment strategy.

For example, when the average error value D is above the first threshold D₁, the existing drive ability is too strong, so the first adjustment strategy may reduce the existing drive ability (for example, reducing the source drive voltage, the source drive current or the duty ratio of the clock signal). When the average error value D is below the second threshold D2, the existing drive ability is too weak, so the second adjustment strategy may increase the existing drive ability (for example, increasing the source drive voltage, the source drive current or the duty ratio of the clock signal).

For example, it is assumed that in case of column inversion driving, the N fixed voltage values written to the N pixel units connected with the second virtual gate line by each data line are P11=5V, P12=−5V, P13=5V, . . . P1i=5V . . . , P1N=−5 respectively. After the charging is finished, the N charging voltage values read on the pixel electrode of the N pixel units are P21−5.1V, P22=−5.09V, P23=5.05V, . . . P2i=5V . . . , P2N=−5.09V respectively. i represents a serial number of the ith data line, P1i is a writing voltage value of the pixel unit connected with the ith data line, and P2i is a charging voltage value on the pixel electrode of the pixel unit connected with the ith data line. The average error value D is calculated using the formula (2). It is assumed that the calculated average error value D=0.05, it means that the charging voltage value charged into the N pixel units of the pixel group practically is greater than the writing fixed voltage value by 0.05 V averagely. It is assumed that the first threshold D₁ has a value of 0.01, and D>D₁, which indicates that the actual source drive voltage of the data line is too high, and the first adjustment strategy should be used to adjust the setting of the drive. The first adjustment strategy may reduce one of the source drive voltage, the source drive current or the duty ratio of the clock signal. Correspondingly, if the average error value D is below the second threshold D₂, the second adjustment strategy should be used to adjust the setting of the drive. The second adjustment strategy may increase one of the source drive voltage, the source drive current or the duty ratio of the clock signal. For example, if the calculated average error value D is above or equal to the second threshold D₂ and is below or equal to the first threshold D₁, the charging error value is within an allowed range, and the drive is not adjusted.

The pixel unit of TFT-LCD changes with an increase in usage time, and such a change would cause abnormal display due to an oversize or undersized voltage charged into the pixel unit via the data line. In the embodiments of the present disclosure, the adjustment strategy is obtained by the average error value, and the setting of the drive may be adjusted based on a dynamic change in the pixel unit on the display panel. Specifically, by integrally adjusting the source drive voltages or the source drive currents charged into the pixel units by all data lines, the charging voltages of the pixel units are maintained within a prescribed range, which effectively improves display quality.

In other embodiments, a plurality of charging error values may further include N independent error values which are used for representing charging error values of the N data lines respectively, where the N independent error values are N difference values obtained in step S203.

For example, when the plurality of charging error values in step S200 include N independent error values, the step S300 of determining an adjustment strategy of the drive based on a plurality of charging error values may include: for each data line: in a case where a corresponding independent error value is above the first threshold, which indicates that the drive to this data line is too large, reducing the ability of the drive corresponding to this data line (for example, reducing the source drive voltage or the source drive current of the data line); or, in a case where a corresponding independent error value is below the second threshold, which indicates that the drive to this data line is too small, increasing the ability of the drive corresponding to this data line (for example, increasing the source drive voltage or the source drive current of the data line). For example, the source drive voltage may be increased or reduced by adjusting the gray-scale voltage output from the source drive. For example, the source drive current may be increased or reduced by adjusting the current output from the source drive. For example, the first threshold is a positive real number, and the second threshold is a negative real number.

For example, in the present disclosure, the one or more charging error values meeting the first condition may indicate that the independent error value corresponding to a certain data line is above the first threshold; the one or more charging error values meeting the second condition may indicate that the independent error value corresponding to a certain data line is below the second threshold.

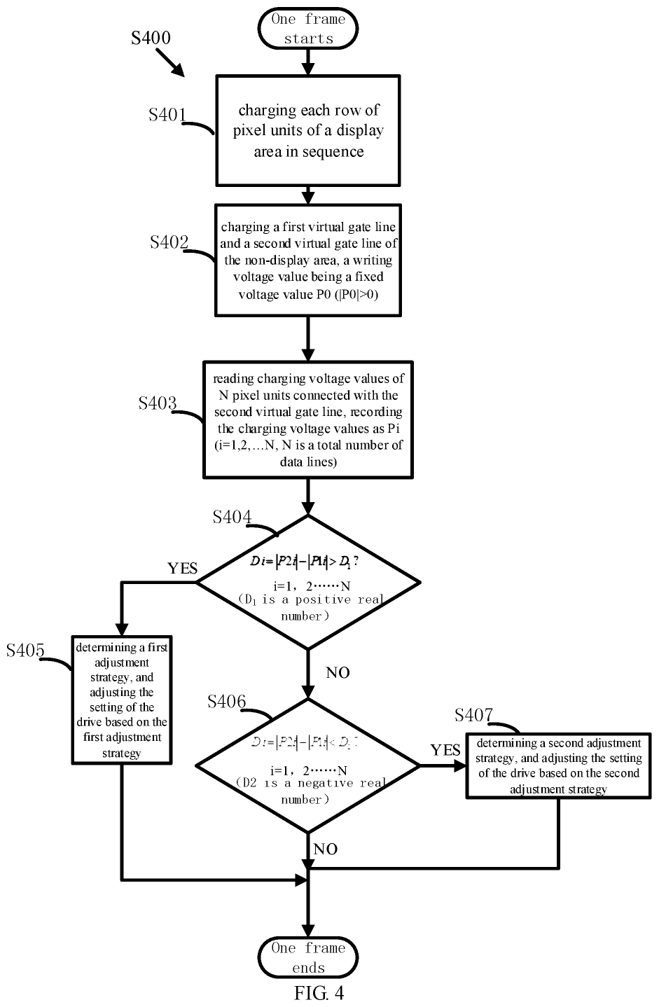

Another embodiment of the present disclosure will be introduced in combination with FIG. 4 below, and the process of obtaining an adjustment strategy based on the independent error value and adjusting the setting of the drive based on the adjustment strategy is explained in detail. It should be noted that in the embodiment shown in FIG. 4, two virtual gate lines are arranged in the non-display area, where N pixel units in the pixel group are connected with the second virtual gate line. It is assumed that the first threshold is D₁ and the second threshold is D₂, where D₁ is a positive real number and D₂ is a negative real number.

Step S401, charging each row of pixel units of a display area in sequence.

Step S402, charging a first virtual gate line and a second virtual gate line of the non-display area, a writing voltage value being a fixed voltage value P0 (|P0|>0).

Step S403, reading charging voltage values of N pixel units connected with the second virtual gate line, recording the charging voltage values as Pi (1=1, 2, . . . N, N is a total number of data lines).

Step S404, comparing each independent error value Di (i=1, 2, . . . N) with the first threshold D₁.

For example, in step S404, N independent error values Di (i=1, 2, . . . N) are calculated one by one using the above-mentioned formula (1), and then each independent error value Di (i=1, 2, . . . N) is compared with the first threshold D₁. The independent error value Di is an error value corresponding to the ith pixel unit which corresponds to the ith data line. When the independent error value Di is above the first threshold D₁, the step S405 is performed on the ith data line, otherwise the step S406 is performed.

Step S405, determining a first adjustment strategy, and adjusting, for example, the setting of the drive of the ith data line based on the first adjustment strategy.

Step S406, comparing the independent error value Di with the second threshold D₂ in a case where the independent error value Di is not above the first threshold D₁, and performing the step S407 on the ith data line, otherwise the drive of the ith data line is not adjusted in a case where the independent error value Di is below the second threshold D₂.

Step S407, determining a second adjustment strategy, and adjusting, for example, the setting of the drive of the ith data line based on the second adjustment strategy.

For example, the first adjustment strategy may reduce one of the source drive voltage and the source drive current. The second adjustment strategy may increase one of the source drive voltage and the source drive current.

For example, it is assumed that in case of column inversion driving, the N fixed voltage values written to the N pixel units connected with the second virtual gate line by each data line are P11=5V, P12=−5V, P13=5V, . . . P1i=5V . . . , P1N=−5 respectively. After the charging is finished, the N charging voltage values read on the pixel electrode of the N pixel units are P21=5.1V, P22=−4.95V, P23=4.90V, . . . P2i=5V . . . , P2N=−5.06V respectively. i represents a serial number of the ith data line, P1i is a writing voltage value of the pixel unit connected with the ith data line, and P2i is a charging voltage value on the pixel electrode of the pixel unit connected with the ith data line. The N independent error values are calculated using the formula (1), obtaining that the independent error value of the first data line D1=0.1, which means that the charging voltage value for the pixel unit by the first data line is greater than the writing voltage value by 0.1 V; the independent error value of the second data line D2=−0.05V, which indicates that the charging voltage value for the pixel unit by the second data line is less than the writing voltage value by 0.05 V, and the same applies to other data lines. If the independent error value corresponding to a certain data line is above the first threshold, the first adjustment strategy may be used to adjust the setting of the source drive of this data line. Correspondingly, if the independent error value corresponding to a certain data line is below the second threshold, the second adjustment strategy may be used to adjust the setting of the drive of this data line. It should be noted that if the independent error value D corresponding to a certain data line is above or equal to the second threshold D₂ and is below or equal to the first threshold D₁, the charging error value of this data line is within an allowed range, and the source drive of this data line is not adjusted.

For a module with a relatively large size, due to the uniformity problem of the display panel, there is a relatively large charging difference among the pixel units at different positions in a gate line direction of the display panel. Therefore, the same drive ability provided for each data line may cause non-uniform display in the gate line direction. In the embodiments of the present disclosure, based on independent error values, different adjustment strategies for each data line may be obtained, self-adaptively adjusting the source drive (for example, increasing or reducing the source drive voltage, the source drive current of each data line), which solves the problem of non-uniform display in the gate line direction due to the display panel with a relatively large size.

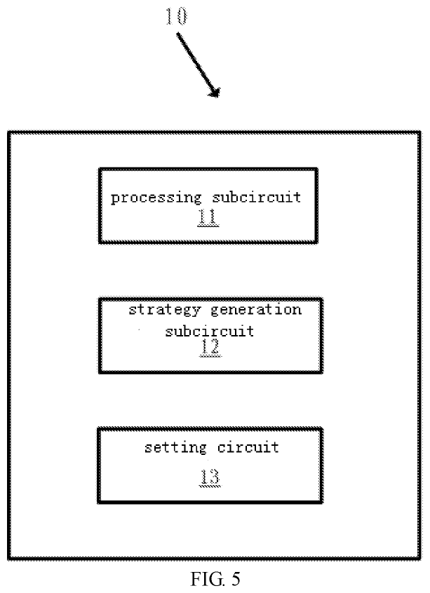

As shown in FIG. 5, the embodiment of the present disclosure provides a drive adjusting circuit 10, including: a processing subcircuit 11, configured to obtain one or more charging error values of a pixel group; a strategy generation subcircuit 12, configured to determine an adjustment strategy of the drive based on the one or more charging error values; and a setting subcircuit 13, configured to adjust a setting of the drive based on the adjustment strategy; where the determining an adjustment strategy of the drive based on the one or more charging error values may include: reducing the drive in a case where the one or more charging error values meet a first condition; and increasing the drive in a case where the one or more charging error values meet a second condition.

In some embodiments, the pixel group includes N pixel units which are charged by N writing voltage values provided by the N data lines respectively, where N is a total number of the data lines and is a positive integer greater than or equal to 1; and the processing subcircuit 11 is further configured to: read N writing voltage values of the N pixel units respectively; measuring the voltage values on the pixel electrodes of the N pixel units, to obtain N charging voltage values; and obtaining N difference values by subtracting absolute values of the N writing voltage values from absolute values of the N charging voltage values, and determining the one or more charging error values based on the N difference values.

For example, an input terminal of the processing subcircuit 11 is connected with the pixel electrodes of N pixel units respectively, so as to read N measured charging voltage values on the pixel electrode of the N pixel units. An output terminal of the processing subcircuit 11 is connected with the strategy generation subcircuit 12.

For example, the N difference values may be calculated in a way of software programming, or by an adder or a multiplier.

In some embodiments, the strategy generation subcircuit 12 is configured to: compare the one or more charging error values (for example, the average error value or one or more independent error values) with set first and second thresholds, to obtain a comparison result; and generate the adjustment strategy for adjusting the drive based on the comparison result; where the first threshold is a positive real number and the second threshold is a negative real number.

For example, the strategy generation subcircuit 12 may include a comparator. The comparator is configured to compare one or more charging error values with the first and second thresholds, and output the comparison result. For example, an output terminal of the strategy generation subcircuit 12 is used for outputting the comparison result. The comparison result may be any one of the following situations: one or more charging error values are above the first threshold, below the second threshold, or between the first threshold and the second threshold. It should be noted that only when the comparison result is that one or more charging error values are above the first threshold or below the second threshold, the strategy generation subcircuit 12 generates the corresponding adjustment strategy of the drive.

In some embodiments, the setting subcircuit 13 is configured to receive the adjustment strategy generated by the strategy generation subcircuit, generate corresponding control signals based on the adjustment strategy, and then input these control signals to the drive circuit to adjust the setting of the drive.

In addition, how to obtain the specific adjustment strategy based on the comparison result may refer to the descriptions related to the method of adjusting the drive, and is not repeated herein.

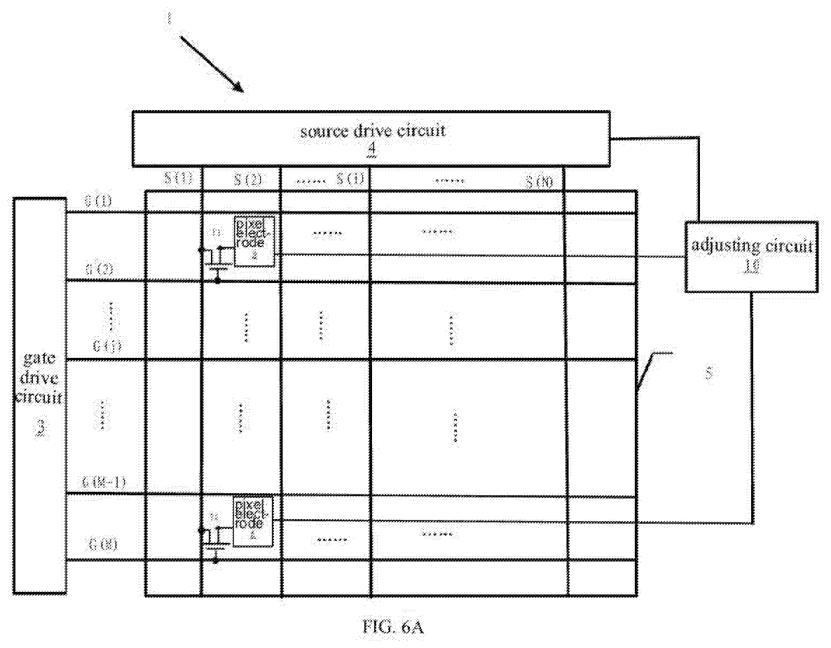

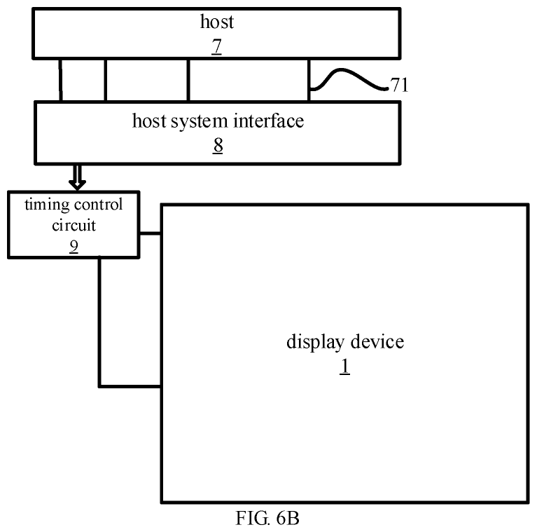

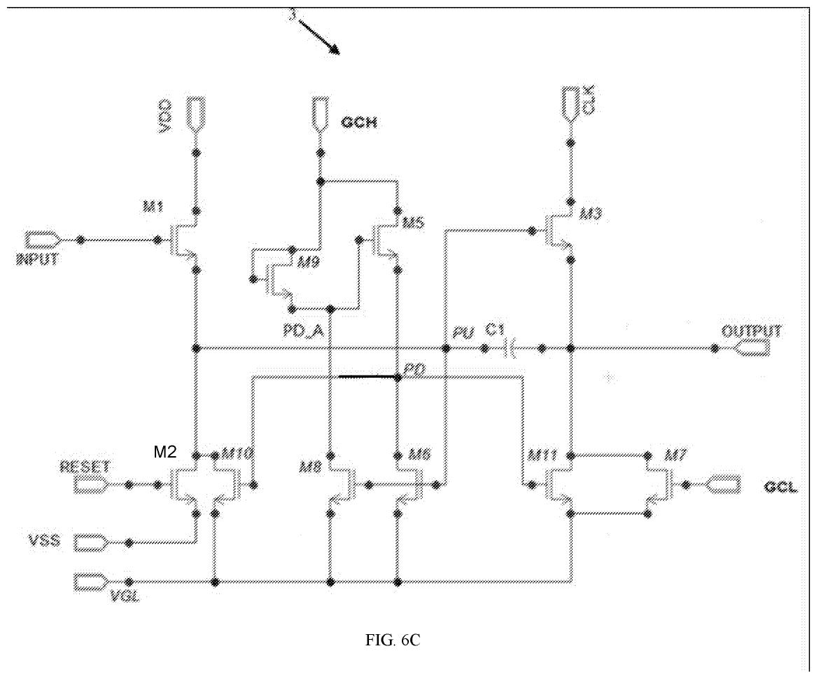

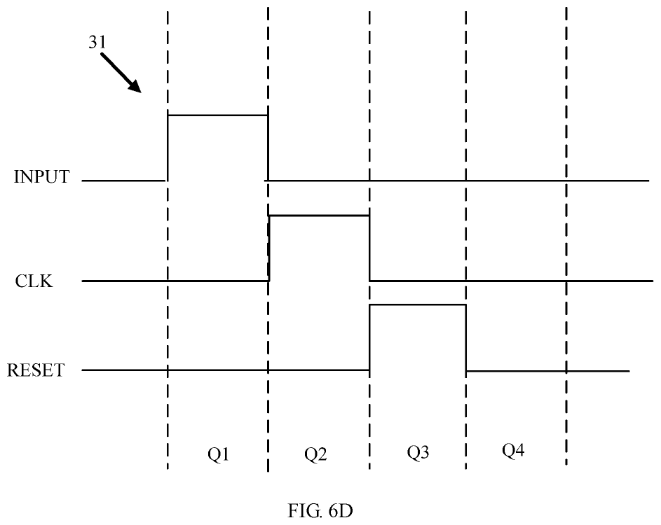

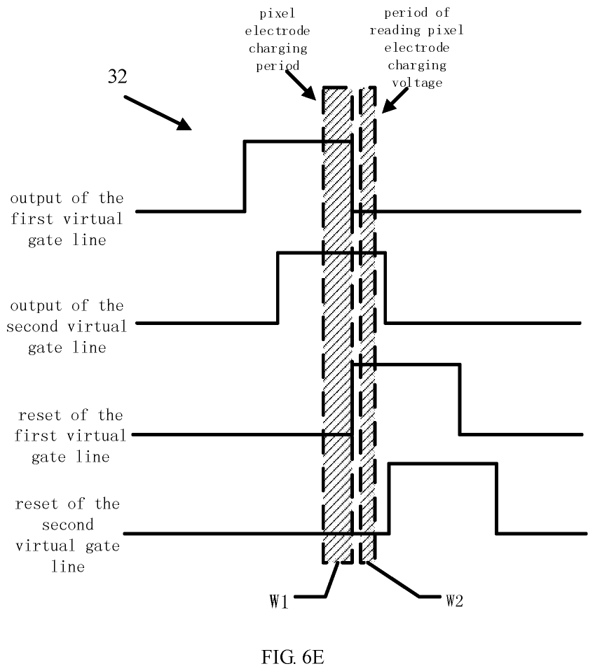

As shown in FIG. 6A, the embodiment of the present disclosure provides a display device 1. The display device 1 includes at least an adjusting circuit 10, a gate drive circuit 3 and a source drive circuit 4. The particular structure and implementation of the adjusting circuit 10 may refer to related descriptions of FIGS. 1-5, and are not repeated herein.

In some embodiments, as shown in FIG. 6A, the display device 1 may further include a display panel 5.

In some embodiments, the adjusting circuit 10 may be located on the display panel 5.

In some embodiments, a plurality of pixel units (located in an area defined by adjacent gate lines and adjacent data lines) is distributed on the display panel 5, where each of the pixel units includes a drive transistor T1 and a pixel electrode 6 (may refer to two pixel units shown in FIG. 6A). First electrodes of the drive transistors T1 are connected with the data lines (S(1), S(2) . . . S(i) . . . S(N)), control electrodes of the drive transistors T1 are connected with the gate lines (G(1), G(2) . . . G(j) . . . G(M−1), G(M)), and second electrodes of the drive transistors T1 are connected with the pixel electrodes 6. The adjusting circuit 10 may be connected with the pixel electrode 6 to measure the charging voltage value of the pixel electrode 6. It should be noted that although the pixel electrodes 6 of the two pixel units shown in FIG. 6A are connected with the adjusting circuit 10, not every pixel electrode 6 of the pixel units on the display panel is required to be connected with the adjusting circuit 10. Only the pixel electrode 6 of the pixel unit belonging to the pixel group is connected with the adjusting circuit 10. For example, in the case where the pixel group is connected with the first gate line G(1), i.e., the pixel group includes N pixel units connected with the first gate line G(1), the pixel electrodes 6 of the N pixel units connected with the first gate line G(1) are connected with the adjusting circuit 10; in the case where the pixel group is connected with the last gate line G(M), i.e., the pixel group includes N pixel units connected with the last gate line G(M), the pixel electrodes 6 of the N pixel units connected with the last gate line G(M) are connected with the adjusting circuit 10.

As shown in FIG. 6B, the display device 1 may be connected with a host 7 by the timing control circuit 9 and a host system interface 8. The host 7 is configured to provide a plurality of frames of image data 71 to the display device 1. The timing control circuit 9 is configured at least to input the control signal to the gate drive circuit 3 and the source drive circuit 4. For example, the timing control circuit 9 may provide the clock signal to the gate drive circuit.

For example, one or more charging error values required by the adjusting circuit 10 may be calculated within a time interval between two adjacent frames of image data the host 7 inputs to the display device I.

For example, the duty ratio of the clock signal, etc., is adjusted by adjusting the timing control circuit 9.

For example, the source drive circuit 4 may configure either the source drive voltage or the source drive current based on the setting of the drive obtained by the adjusting circuit 10.

For example, the time taken by the high level output from the gate drive circuit 3 may be adjusted by adjusting the duty ratio of the timing signal, thereby affecting the charging voltage value of the pixel. Specifically, the duty ratio of the timing signal may be adjusted by adjusting the timing control circuit (not shown in FIG. 6B).

In some embodiments, the gate drive circuit 3 includes several stages of cascaded shift register (GOA) units, and each of the shift register units has a circuit structure as shown in FIG. 6C (that is. FIG. 6C shows the GOA unit at a stage).

The function of the several stages of cascaded GOA units is to output a high-level square wave to each of the gate lines (G(1), G(2) . . . G(j) . . . G(M−1), G(M)) orderly within one frame time, and turn on the drive transistors T1 corresponding to these gate lines progressively, so as to finish charging of all pixel units on the display unit panel by the data lines (S(1), S(2) . . . S(i) . . . S(N)).

In some embodiments, for the display panel with a medium or relatively large size, due to a relatively large gate line load, in order to normally turn on gate lines, dual-side driving may be adopted. The dual-side driving refers to the arrangement of GOA units at left and right sides of one gate line to perform charging. In this case, the GOA units at left and right sides may be symmetrical completely.

The GOA unit shown in FIG. 6C includes: a storage capacitor C1, a first transistor M1, a second transistor M2, a third transistor M3, a fifth transistor M5, a sixth transistor M6, a seventh transistor M7, an eighth transistor M8, a ninth transistor M9, a tenth transistor M10 and an eleventh transistor M11.

The first electrode of the first transistor M1 is connected with a first voltage terminal VDD to receive an input first DC voltage signal, the second electrode of the first transistor M1 is connected with a pull-up node PU, and the control electrode of the first transistor M1 is connected with the input terminal INPUT to receive the input signal.

The first electrode of the second transistor M2 is connected with the pull-up node PU, the second electrode of the second transistor M2 is connected with the second voltage terminal VSS to receive an input second DC voltage, and the control electrode of the second transistor M2 is connected with a reset signal terminal RESET to receive a reset signal.

The first electrode of the third transistor M3 is connected with a clock signal terminal CLK to receive the clock signal, the second electrode of the third transistor M3 is connected with the output terminal OUTPUT, and the control electrode of the third transistor M3 is connected with the pull-up node PU.

The first electrode of the fifth transistor M5 is connected with a third voltage terminal GCH to receive an input third DC voltage, the second electrode of the fifth transistor M5 is connected with a pull-down node PD, and the control electrode of the fifth transistor M5 is connected with the pull-down control node PD-A.

The first electrode of the sixth transistor M6 is connected with the pull-down node PD, the second electrode of the sixth transistor M6 is connected with a fourth voltage terminal VGL to receive an input fourth DC voltage, and the control electrode of the sixth transistor M6 is connected with the pull-up node PU.

The first electrode of the seventh transistor M7 is connected with the output terminal OUTPUT, the second electrode of the seventh transistor M7 is connected with the fourth voltage terminal VGL to receive an input fourth DC voltage, and the control electrode of the seventh transistor M7 is connected with a fifth voltage terminal GCL to receive a fifth DC voltage. The fourth DC voltage may be, for example, a low voltage.

The first electrode of the eighth transistor M8 is connected with a pull-down control node PD-A, the second electrode of the eighth transistor M8 is connected with the fourth voltage terminal VGL to receive an input fourth DC voltage, and the control electrode of the eighth transistor M8 is connected with the pull-up node PU.

The first electrode of the ninth transistor M9 is connected with the third voltage terminal GCH to receive an input third DC voltage, the second electrode of the ninth transistor M9 is connected with the pull-down control node PD-A, and the control electrode of the ninth transistor M9 is connected with the third voltage terminal GCH to receive an input third DC voltage. The third DC voltage may be, for example, a high voltage.

The first electrode of the tenth transistor M10 is connected with the pull-up node PU, the second electrode of the tenth transistor M10 is connected with the fourth voltage terminal VGL to receive the input fourth DC voltage, and the control electrode of the tenth transistor M10 is connected with the pull-down node PD.

The first electrode of the eleventh transistor M11 is connected with the output terminal OUTPUT, the second electrode of the eleventh transistor M11 is connected with the fourth voltage terminal VGL to receive the input fourth DC voltage, and the control electrode of the eleventh transistor M11 is connected with the pull-down node PD.

The first terminal of the storage capacitor C1 is connected with the pull-up node PU, and the second terminal of the storage capacitor C1 is connected with the output terminal OUTPUT.

The output terminal OUTPUT of the GOA unit shown in FIG. 6C is connected with the gate line shown in FIG. 6A.

It should be noted that the GOA unit shown in FIG. 6C is only an example according to the embodiments of the present disclosure, and the embodiments of the present disclosure include, but is not limited to, the configuration shown in FIG. 6C.

For example, the gate drive circuit 3 formed by cascading several stages of GOA units of FIG. 6C has the following operation process. When a frame starts, a required first trigger signal and a clock signal are input to the GOA unit at the first stage. The GOA unit at the first stage receives the first trigger, and outputs a high-level square wave signal when the corresponding clock signal CLK is at a high level. This output high-level square wave signal is not only used for turning on corresponding gate lines, but also acting on the GOA unit at the next stage as an input signal. Starting from the GOA unit at the second stage, subsequent GOA units receive the input signal provided by the GOA unit at the previous stage, and output high-level square wave signals in the case where the corresponding CLK is at a high level. The output high-level square wave signal is not only used for turning on corresponding gate lines, but also acting on the GOA unit at the next stage as an input signal and acting on the GOA unit at the previous stage as a reset signal. This does not apply to the output of the GOA unit at the last stage (as described above, the GOA unit at the last stage does not need to use the output high-level square wave signal as the input signal for the next stage). When a row starts outputting, the GOA unit at each stage of this row turns off the signal output from the previous row of GOA units, and the GOA unit at the next stage also starts outputting and turning off the signal output from this row at the end of outputting of this row. As such, each GOA unit may output high-level square wave signals orderly, and realizes the shift register function.

It should be noted that the transistors adopted in the embodiments of the present disclosure may all be thin film transistors, field effect transistors or a switching elements with identical characteristics. The control electrode of the transistor is the gate of the transistor. The source and drain of the transistor used herein are symmetrical structurally, so they may have no difference in the structure. In the embodiments of the present disclosure, in order to distinguish the two electrodes of the transistor other than the gate, one of the drain and the source is referred to as a first electrode, and the other is referred to as a second electrode, so the first and second electrodes of all or partial transistors in the embodiments of the present disclosure may be interchanged as needed. For example, the first electrode of the transistor according to embodiments of the present disclosure may be the source, the second electrode may be the drain, or the first electrode of the above-mentioned transistor may be the drain, and the second electrode is the source. In addition, the transistors may be divided into N-type transistors and P type transistors according to the characteristics of the transistors. In the case where P-type transistors are used, the turn-on voltage is a low-level voltage (for example, 0V, −5V, or other numerical values), and the turn-off voltage is a high-level voltage (for example, 5V, 10V or other numerical values); in the case where N-type transistors are used, the turn-on voltage is a high-level voltage (for example, 5V, 10V, or other numerical values), and the turn-off voltage is a low-level voltage (for example, 0V, −5V or other numerical values).

It should be noted that the embodiments of the present disclosure are explained by taking N-type transistors as an example. Based on descriptions and teachings of the embodiments in the present disclosure, persons skilled in the art would conceive the implementations where the embodiment of the present disclosure adopts P-type transistors or the combination of N-type transistors with P-type transistors without any creative work. Therefore, these embodiments also fall within the protection scope of the present disclosure.

FIG. 6D is a drive timing diagram. The operation process of driving the GOA unit in FIG. 6C will be explained below in combination with the timing diagram of FIG. 6D.

The first phase Q1 is an input phase, at which the reset signal at the reset signal terminal RESET and the clock signal at the clock signal terminal CLK are set to low levels, and the input signal at the input terminal INPUT is at a high level (the high-level square wave on the INPUT signal in FIG. 6D).

Due to the low-level reset signal, the second transistor M2 is turned off; the input signal is at a high level, the first transistor M1 is turned on, and the storage capacitor C1 is charged by the first transistor M1. At this point, the pull-up node PU is at a high level, and the sixth transistor M6 and the eighth transistor M8 are turned on, thereby writing the fourth DC voltage at the fourth voltage terminal VGL into the pull-down node PD. The pull-down node PD is at a low level, and the tenth transistor M10 and the eleventh transistor M11 are turned off, thereby ensuring normal input. Since the pull-up node PU is at a high level, the third transistor M3 is turned on. Due to the low-level clock signal, the output terminal OUTPUT outputs a low level.

The second phase Q2 is an output phase, at which the input signal and the reset signal are at low levels, and the clock signal is at a high level. Due to the maintenance of the storage capacitor C1, the pull-up node PU is at a high level, the third transistor M3 is turned on, the clock signal is at a high level, and the output terminal OUTPUT outputs a high level. At this point, the pull-down node PD is at a low level, and the tenth transistor M10 and the eleventh transistor M11 are turned off, thereby ensuring the normal output.

The third phase Q3 is a reset phase, at which the clock signal and the input signal are at low levels, and the reset signal is at a high level. Due to the high-level reset signal, the second transistor M2 is turned on, the pull-up node PU is at a low level, and the sixth transistor M6 and the eighth transistor M8 are turned off. The fifth transistor M5 and the ninth transistor are turned on, thereby writing the third DC voltage at the third voltage terminal GCH into the pull-down node PD, and thus the pull-down node PD is at a high level and the tenth transistor M10 and the eleventh transistor M11 are turned on. The pull-up node PU and the signal at the output terminal are both at low levels.

The fourth phase Q4 is a maintaining phase, at which the clock signal, the input signal and the reset signal are at low levels. Due to the low-level clock signal, the low-level input signal and the low-level reset signal, the first transistor M1 and the second transistor M2 are turned off. The pull-up node PU is at a low level, and the sixth transistor M6 and the eighth transistor M8 are turned off. The pull-down node PD is at a high level, the tenth transistor M10 and the eleventh transistor M11 are turned on, and the potentials of the pull-up node PU and the output terminal OUTPUT are kept at low levels.

During the period after the fourth phase Q4 starts and before the next frame, the circuit of the above-mentioned GOA unit works at the fourth phase Q4.

In some embodiments, the non-display area on the display panel 5 is provided with two virtual gate lines. FIG. 6E is a schematic diagram which shows charging the pixel unit connected with the two virtual gate lines and reading the charging voltage values. As shown in FIG. 6E, when the output from the first virtual gate line ends, the reset signal is provided to the first virtual gate line to reset the output of the first virtual gate line. Similarly, when the output from the second virtual gate line ends, the reset signal is provided to the second virtual gate line to reset the output of the second virtual gate line. Referring to FIG. 6E, during the W1 period, the pixel unit connected with the first virtual gate line and the pixel unit connected with the second virtual gate line are both at the charging phase. When the W1 period ends, the charging period of the pixel electrode of the pixel unit connected with the first virtual gate line ends, and the charging period of the pixel unit connected with the second virtual gate line lasts for some time. During the W2 period, when the first virtual gate line is at the reset phase initially, the second virtual gate line is still at the period when charging is coming to an end. For example, in the embodiment of the present disclosure, the charging voltage value of the pixel group may be read during the W2 period.

Although the first virtual gate line is turned off during the W2 period, the existence of the capacitor in the pixel unit keeps the charging voltage value of the pixel unit connected with the second virtual gate line maintained during this period (that is, the W2 period), and the charging phase is close to the end, there is little electric leakage, and the charging voltage value of the pixel group read within the W2 period is closest to a true charging voltage value.

Referring to FIGS. 1-5, the similar description of the adjusting circuit 10 is not repeated herein.

The foregoing descriptions are merely exemplary embodiments of the present disclosure, and the protection scope of the present disclosure is not limited thereto. A person skilled in the art may easily conceive various modifications or substitutions within the technical scope of the present disclosure. All such modifications and substitutions shall fall within the protection scope of the present disclosure. Therefore, the protection scope of the present disclosure shall be defined by the claims.

1. A method of adjusting a drive, comprising:
obtaining a charging error value of a pixel group;
determining an adjustment strategy of the drive based on the charging error value; and
adjusting a setting of the drive based on the adjustment strategy,
wherein the determining an adjustment strategy of the drive based on the charging error value comprises:
reducing the drive in a case where the charging error value meets a first condition; and
increasing the drive in a case where the charging error value meets a second condition.

2. The method of adjusting the drive according to claim 1, wherein each pixel unit in the pixel group is connected with a same scan line which is a gate line or a virtual gate line.

3. The method of adjusting the drive according to claim 2, wherein
the pixel group comprises N pixel units which are charged by N writing voltage values provided by N data lines, wherein N is a total number of the data lines and is a positive integer greater than or equal to 1; and
the obtaining a charging error value of a pixel group comprises:
reading N writing voltage values of the N pixel units respectively;
measuring voltage values on pixel electrodes of the N pixel units to obtain N charging voltage values; and
obtaining N difference values by subtracting absolute values of the N writing voltage values from absolute values of the N charging voltage values, and determining the charging error value based on the N difference values.

4. The method of adjusting the drive according to claim 2, wherein the N writing voltage values are N data voltage values or N set fixed voltage values.

5. The method of adjusting the drive according to claim 3, wherein
the scan line is connected with gates of drive transistors of the pixel units, the drive transistors are turned on under a control of a turn-on voltage provided by the scan line; and
the obtaining N charging voltage values comprises reading the N charging voltage values before the drive transistors are turned off.

6. The method of adjusting the drive according to claim 3, wherein the charging error value is an average error value, the average error value is an average of the N difference values, and the average error value is used for representing an average charging error of the N data lines.

7. The method of adjusting the drive according to claim 6, wherein the determining an adjustment strategy of the drive based on the charging error value comprises:
reducing a source drive voltage, a source drive current or a duty ratio of a dock signal in a case where the average error value is above a first threshold; or
increasing the source drive voltage, the source drive current or the duty ratio of the clock signal in a case where the average error value is below a second threshold,
wherein the first threshold is a positive real number, and the second threshold is a negative real number.

8. The method of adjusting the drive according to claim 3, wherein the charging error value comprises N independent error values, and the N independent error values are the N difference values and are used for representing charging error values of the N data lines respectively.

9. The method of adjusting the drive according to claim 8, wherein the determining an adjustment strategy of the drive based on the charging error value comprises:
for each data line:
reducing a source drive voltage or a source drive current of the data line in a case where the independent error value corresponding to the data line is above the first threshold; or
increasing the source drive voltage or the source drive current of the data line in a case where the independent error value corresponding to the data line is below the second threshold,
wherein the first threshold is a positive real number, and the second threshold is a negative real number,

10. The method of adjusting the drive according to claim 3, wherein the obtaining N difference values by subtracting absolute values of the N writing voltage values from absolute values of the N charging voltage values comprises:
obtaining a time interval between two adjacent frames of image data a host inputs to a drive circuit; and
calculating the N difference values within the time interval.

11. A drive adjusting circuit, comprising:
a processing subcircuit, configured to obtain a charging error value of a pixel group;
a strategy generation subcircuit, configured to determine an adjustment strategy of the drive based on the charging error value; and
a setting subcircuit, configured to adjust a setting of the drive based on the adjustment strategy,
wherein the strategy generation subcircuit is further configured to reduce the drive in a case where the charging error value meets a first condition; and to increase the drive in a case where the charging error value meets a second condition.

12. The drive adjusting circuit according to claim 11, wherein the pixel group comprises N pixel units which are charged by N writing voltage values provided by N data lines respectively, wherein N is a total number of the data lines and is a positive integer greater than or equal to 1; and
the processing subcircuit is further configured to:
read N writing voltage values of the N pixel units respectively;
measure voltage values on pixel electrodes of the N pixel units to obtain N charging voltage values; and
obtain N difference values by subtracting absolute values of the N writing voltage values from absolute values of the N charging voltage values, and determine the charging error value based on the N difference values.

13. The drive adjusting circuit according to claim 11, wherein the strategy generation subcircuit is further configured to: compare the charging error value with a set first threshold and a set second threshold to obtain a comparison result; and generate the adjustment strategy for adjusting the drive based on the comparison result, wherein the first threshold is a positive real number and the second threshold is a negative real number.

14. The drive adjusting circuit according to claim 11, wherein each pixel unit in the pixel group is connected with a same scan line, and the scan line is a gate line or a virtual gate line.

15. A display device, comprising the drive adjusting circuit according to claim 11, a gate drive circuit and a source drive circuit, wherein
the gate drive circuit is configured to configure a source drive voltage or a source drive current based on the setting of the drive; and
the gate drive circuit is configured to reduce or increase a time taken by an output gate drive signal based on the setting of the drive.

16. The method of adjusting the drive according to claim 4, wherein
the scan line is connected with gates of drive transistors of the pixel units, the drive transistors are turned on under a control of a turn-on voltage provided by the scan line; and
the obtaining N charging voltage values comprises reading the N charging voltage values before the drive transistors are turned off.

17. The method of adjusting the drive according to claim 4, wherein the charging error value is an average error value, the average error value is an average of the N difference values, and the average error value is used for representing an average charging error of the N data lines.

18. The method of adjusting the drive according to claim 5, wherein the charging error value is an average error value, the average error value is an average of the N difference values, and the average error value is used for representing an average charging error of the N data lines.

19. The method of adjusting the drive according to claim 4, wherein the charging error value comprises N independent error values, and the N independent error values are the N difference values and are used for representing charging error values of the N data lines respectively.

20. The method of adjusting the drive according to claim 5, wherein the charging error value comprises N independent error values, and the N independent error values are the N difference values and are used for representing charging error values of the N data lines respectively.
